(19) United States
(12) Patent Application Publication
(10) Pub. No.: US 2015/0177539 A1
(43) Pub. Date: Jun. 25, 2015

(54) LIQUID CRYSTAL DISPLAY DEVICE

(71) Applicant: InnoLux Corporation, Miao-Li County (TW)

(72) Inventors: Hungming SHEN, Miao-Li County (TW); Wanling HUANG, Miao-Li County (TW); Kai-neng YANG, Miao-Li County (TW); Tsau-Hua HSIEH, Miao-Li County (TW)

(21) Appl. No.: 14/568,395

(22) Filed: Dec. 12, 2014

(30) Foreign Application Priority Data
Dec. 24, 2013 (TW) 102147841

(51) Int. Cl. G02F 1/1337; C09K 19/56

(52) U.S. Cl. CPC G02F 1/1337; G02F 1/133788; G02F 1/133707; C09K 19/56

(57) ABSTRACT

The present invention relates to a liquid crystal display device, comprising: a first substrate with a first alignment layer disposed thereon; a second substrate with a second alignment layer disposed thereon; and a liquid crystal layer, comprising a negative liquid crystal composition and interposed between the first substrate and the second substrate, wherein the first alignment layer and the second alignment layer are disposed opposite to each other. In the present invention, at least one of the first alignment layer and the second alignment layer has a volume resistivity of 1.5×10¹² to 9×10¹⁵ Ω·cm, at least one of the first alignment layer and the second alignment layer absorbs a light having a wavelength of 240 nm to 400 nm, or a surface of at least one of the first alignment layer and the second alignment layer includes a plurality of protrusions formed by polymerizing a UV reactive monomer.

### CROSS REFERENCE TO RELATED APPLICATION

This application claims the benefits of the Taiwan Patent Application Serial Number 102147841, filed on Dec. 24, 2013, the subject matter of which is incorporated herein by reference.

### BACKGROUND OF THE INVENTION

1. Field of the Invention

The present invention relates to a liquid crystal display device, and especially to a liquid crystal display device using a negative liquid crystal and having voltage holding ratio of 85% or more.

2. Description of Related Art

A liquid crystal display device controls the amount of light transmission by orienting liquid crystal molecules to provide different polarization or refraction effects on incident light, thus producing an image.

A typical twisted nematic (TN) liquid crystal display device has a very narrow viewing angle due to the limitations of the structure and optical properties of the liquid crystal molecules. Therefore, other types of liquid crystal display devices having a wide viewing angle are developed, for example: a vertical alignment (VA) liquid crystal display device, an in-plane switch (IPS) liquid crystal display, and a fringe field switching (FFS) liquid crystal display.

Depending on the rotation characteristics of the liquid crystal molecules in an electric field, the liquid crystal molecules can be classified into positive and negative liquid crystal molecules. Generally, the positive liquid crystal molecules have an advantage of fast response time, but they have low light transmittance. On the contrary, the negative liquid crystal molecules have high light transmittance, but have the shortcoming of longer response time. Accordingly, in the IPS and FFS liquid crystal display devices, when negative liquid crystal molecules are used to constitute the liquid crystal layer, the liquid crystal molecules having a smaller molecular weight are usually added, to facilitate the slippage between the negative liquid crystal molecules, thereby reducing response time. However, when the liquid crystal composition constituting the liquid crystal layer is heated or irradiated by an external ambient light, the small liquid crystal molecules are easily cleaved to generate electrons or radicals, and the generated electrons will be lost from the alignment layer, such that the liquid crystal display device may have a decreased voltage holding ratio (VHR), causing abnormal alignment, thereby affecting blur and optical performance of the liquid crystal display device.

To overcome the above disadvantages, what is desired is to develop a liquid crystal display device using a negative liquid crystal and having high voltage holding ratio by reducing the generation of the electrons or radicals in the liquid crystal layer or the loss of the electrons from the liquid crystal layer.

### SUMMARY OF THE INVENTION

An object of the present invention is to provide a liquid crystal display device, to achieve high voltage holding ratio by disposing an alignment film having a high volume resistivity.

To achieve the above object, the present invention provides a liquid crystal display device, comprising: a first substrate with a first alignment layer disposed thereon; a second substrate with a second alignment layer disposed thereon; and a liquid crystal layer, comprising a negative liquid crystal composition and interposed between the first substrate and the second substrate, wherein the first alignment layer and the second alignment layer are disposed opposite to each other, and at least one of the first alignment layer and the second alignment layer has a volume resistivity of 1.5×10¹² to 9×10¹⁵ Ω·cm.

Another object of the present invention is to provide a liquid crystal display device, in which an alignment film capable of absorbing light from the external environment is disposed to avoid the generation of reactive ions, such as electrons and radicals, in the liquid crystal composition to thereby achieve high voltage holding ratio.

To achieve the above object, the present invention provides a liquid crystal display device comprising a first substrate with a first alignment layer disposed thereon; a second substrate with a second alignment layer disposed thereon; and a liquid crystal layer, comprising a negative liquid crystal composition and interposed between the first substrate and the second substrate, wherein the first alignment layer and the second alignment layer are disposed opposite to each other, and at least one of the first alignment layer and the second alignment layer may absorb a light having a wavelength of 240 nm to 400 nm.

A further object of the invention is to provide a liquid crystal display device, in which suitable UV reactive monomers are added to suppress the generation of reactive ions, such as radicals immediately, to thereby achieve high voltage holding ratio.

To achieve the above object, the present invention provides a liquid crystal display device, comprising: a first substrate with a first alignment layer disposed thereon; a second substrate with a second alignment layer disposed thereon; and a liquid crystal layer, comprising a negative liquid crystal composition and interposed between the first substrate and the second substrate, wherein the first alignment layer and the second alignment layer are disposed opposite to each other, and a surface of at least one of the first alignment layer and the second alignment layer comprises a plurality of protrusions formed by polymerizing UV reactive monomers.

In the liquid crystal display device of the present invention, at least one of the first alignment layer and the second alignment layer may have the volume resistivity of the above range, at least one of the first alignment layer and the second alignment layer may absorb a light having a wavelength of the above range, or at least one of the first alignment layer and the second alignment layer may include a plurality of protrusions formed by polymerizing the UV reactive monomers. However, in an embodiment, at least one of the first alignment layer and the second alignment layer may both have the volume resistivity within the above range and absorb the light having a wavelength of the above range. In other words, at least one of the first alignment layer and the second alignment layer may have a volume resistivity of 1.5×10¹² to 9×10¹⁵ Ω·cm, and at least one of the first alignment layer and the second alignment layer may absorb a light having a wavelength of 240 nm to 400 nm. Further, in another embodiment, at least one of the first alignment layer and the second alignment layer not only may have a volume resistivity of 1.5×10¹² to 9×10¹⁵ Ω·cm or absorb a light having a wavelength of 240 nm to 400 nm, but also may include a plurality of protrusions formed by polymerizing a UV reactive monomer. Furthermore, in still another embodiment, at least one of the first alignment layer and the second alignment layer not only may have a volume resistivity of 1.5×10¹² to 9×10¹⁵ Ω·cm and absorb a light having a wavelength of 240 nm to 400 nm, but also may include a plurality of protrusions formed by polymerizing a UV reactive monomer.

In an embodiment, the first alignment layer and the second alignment layer may be each independently a photo alignment layer.

In the liquid crystal display device of the present invention, based on the total weight of the negative liquid crystal composition, the content of the UV reactive monomer may be greater than 0 to 0.3 wt %.

In an embodiment, the UV reactive monomer may be at least one selected from the group consisting of the compounds of Formula (I) to Formula (IV):

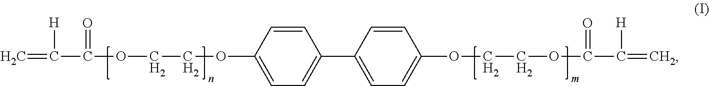

wherein, 0≦m≦5, 0≦n≦5;

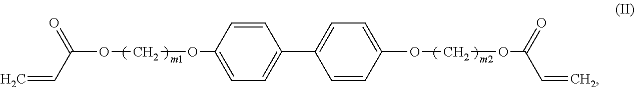

wherein, 1≦m1≦7, 1≦m2≦7;

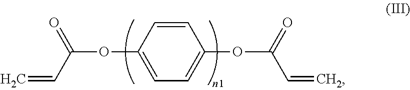

wherein, 1≦n1≦5, and

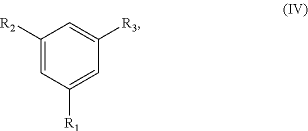

wherein, R₁, R₂ and R₃ are each independently an acrylic group having the following formula:

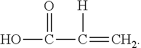

In an embodiment, the UV reactive monomer may be further included in the liquid crystal layer.

### BRIEF DESCRIPTION OF THE DRAWINGS

FIG. 1 shows the schematic structures of the liquid crystal display devices according to Examples 1-3 of the present invention and Comparative Example.

FIG. 2 shows the schematic structure of the liquid crystal display device according to Example 4.

### DETAILED DESCRIPTION OF THE PREFERRED EMBODIMENT

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention, and those skilled in the art will appreciate that various modifications, additions and substitutions are possible.

In the present invention, the liquid crystal display device comprises: a first substrate with a first alignment layer disposed thereon; a second substrate with a second alignment layer disposed thereon; and a liquid crystal layer which may comprise a negative liquid crystal composition and be interposed between the first substrate and the second substrate, wherein the first alignment layer and the second alignment layer may be disposed opposite to each other, and the first alignment layer and the second alignment layer may alone or both: have the above specific volume resistivity of 1.5×10¹² to 9×10¹⁵ Ω·cm; absorb a light having the above specific wavelength of 240 nm to 400 nm; and include the UV reactive monomers on the surface thereof.

In other words, the first alignment layer and the second alignment layer of the liquid crystal display device according to the present invention may each independently comprise at least one of the above features but not particularly limited thereto. For example, in an embodiment, at least one of the first alignment layer and the second alignment layer not only may have a volume resistivity of 1.5×10¹² to 9×10¹⁵ Ω·cm, more preferably 2×10¹³ to 9×10¹⁵Ω, but also absorb a light having a wavelength of 240 nm to 400 nm. More specifically, in an embodiment of the liquid crystal display device of the present invention, only the first alignment layer has a volume resistivity of 1.5×10¹² to 9×10¹⁵ Ω·cm, and more preferably 2×10¹³ to 9×10¹⁵Ω, while the second alignment layer may also absorb a light having a wavelength of 240 nm to 400 nm. Conversely, in another embodiment of the liquid crystal display device of the present invention, only the second alignment layer has a volume resistivity of 1.5×10¹² to 9×10¹⁵ Ω·cm, and more preferably 2×10¹³ to 9×10¹⁵Ω, while the first alignment layer may absorb a light having a wavelength of 240 nm to 400 nm. Alternatively, in a further embodiment of the liquid crystal display device of the present invention, the first and second alignment layers both have a volume resistivity of 1.5×10¹² to 9×10¹⁵ Ω·cm, and more preferably 2×10¹³ to 9×10¹⁵Ω, while they may both absorb a light having a wavelength of 240 nm to 400 nm. In addition, in an embodiment, the first alignment layer has a volume resistivity of 1.5×10¹² to 9×10¹⁵ Ω·cm, and more preferably 2×10¹³ to 9×10¹⁵Ω, and the surface of the first alignment layer may optionally include a plurality of protrusions formed by polymerizing a UV reactive monomer; while the second alignment layer may optionally absorb a light having a wavelength of 240 nm to 400 nm, and the surface of the second alignment layer may optionally include a plurality of protrusions formed by polymerizing a UV reactive monomer.

In the present invention, the UV reactive monomer may be at least one selected from the group consisting of the compounds of Formula (I) to Formula (IV):

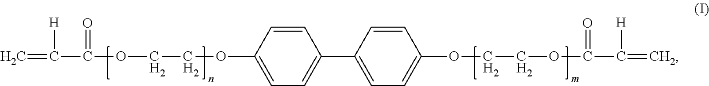

wherein, 0≦m≦5, 0≦n≦5;

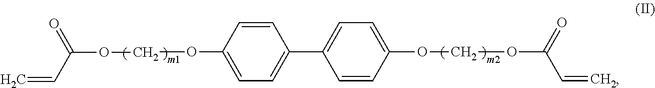

wherein, 1≦m1≦7, 1≦m2≦7;

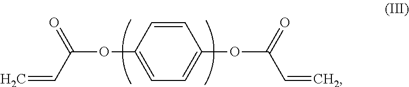

wherein, 1≦n1≦5, and

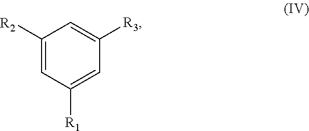

wherein, R₁, R₂ and R₃ are each independently an acrylic group having the following formula:

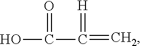

Specifically, those having ordinary skill in the art can use at least one of the compounds of Formula (I) to Formula (IV) alone or the combination of two or more thereof as the UV reactive monomer of the present invention. For example, in an embodiment, the reactive monomer may be the compound of Formula (I). However, any of the compounds of Formula (II) to Formula (IV) may be used alone or a combination of two or more of the compounds of Formula (I) to Formula (IV) may be used as the UV reactive monomer of the present invention, but the present invention is not particularly limited thereto. Furthermore, as long as the transmittance of the alignment layer can be maintained within a suitable range, the content of the UV reactive monomer in the present invention is not particularly limited. For example, based on the total weight of the negative liquid crystal composition, the content of the UV reactive monomer may be greater than 0 to 0.3 wt %. Further, the UV reactive monomer may also be included in the liquid crystal layer, thereby inhibiting the generation of active ions such as radicals immediately, to maintain high voltage holding ratio.

In the present invention, polyimide (PI) which can render higher volume resistivity to the alignment layer may be used as the first and second alignment layers having the volume resistivity of 1.5×10¹² to 9×10¹⁵ Ω·cm, for example:

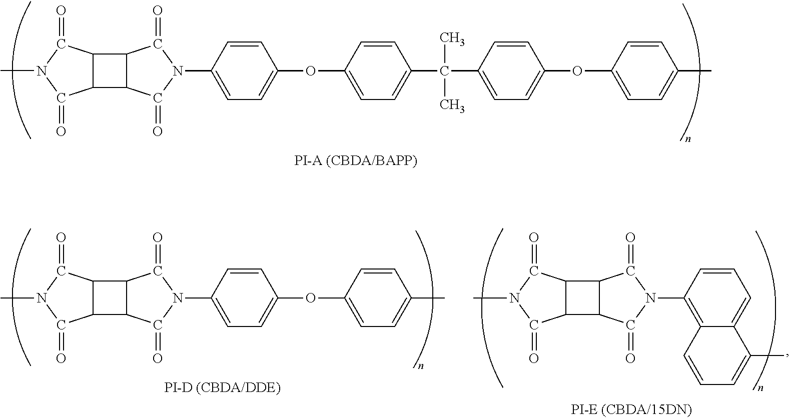

but the present invention is not particularly limited thereto.

In the present invention, as long as the first alignment layer and the second alignment layer of the liquid crystal display device have the above characteristics, the person skilled in the art may employ any conventional materials and methods for their manufacture. For example, polyimide can be used as the material to prepare the first alignment layer and the second alignment layer by photo alignment (such as photo-isomerization, photo-crosslinking and photo-dimerization, and photo-cleavage etc.) or rubbing alignment, but the present invention is not particularly limited thereto. Preferably, in an embodiment, the first alignment layer and the second alignment layer may be each independently a photo alignment layer prepared by photo alignment. More specifically, the first alignment layer and the second alignment layer may be each independently a film made of polyimide and prepared by a photo-cleavage process.

In addition, the types of the liquid crystal display device (i.e., the types of the liquid crystal display panel) according to the present invention is not particularly limited, and for example, a vertical alignment (VA) liquid crystal display device, an in-plan switch (IPS) liquid crystal display, or a fringe field switching (FFS) liquid crystal display may be used. Here, in the following Examples and Comparative Example in the present invention, the in-plan switch (IPS) liquid crystal display is taken as an example. Further, the first and second substrates included in the liquid crystal display device of the present invention may be a combination of a color filter substrate and a thin film transistor substrate. Here, in the following Examples and Comparative Example, a color filter substrate is used as the first substrate, and a thin film transistor substrate is used as the second substrate, for example. However, the liquid crystal display device of the present invention can also have different variations when applying other technologies. For example, the color filter layer may be disposed on the thin film transistor substrate (color filter on array, COA), the color filter layer and the black matrix may be disposed on the thin film transistor substrate (black matrix on array, BOA), or the thin film transistor array may be disposed on the color filter substrate (TFT on CF, also known as TOC or array on CF).

Furthermore, although the following Examples and Comparative Example do not specifically describe all of the components for the purpose of brevity, those having ordinary skill in the art should understand that the liquid crystal display device of the present invention may also include other components, such as a backlight module and so on.

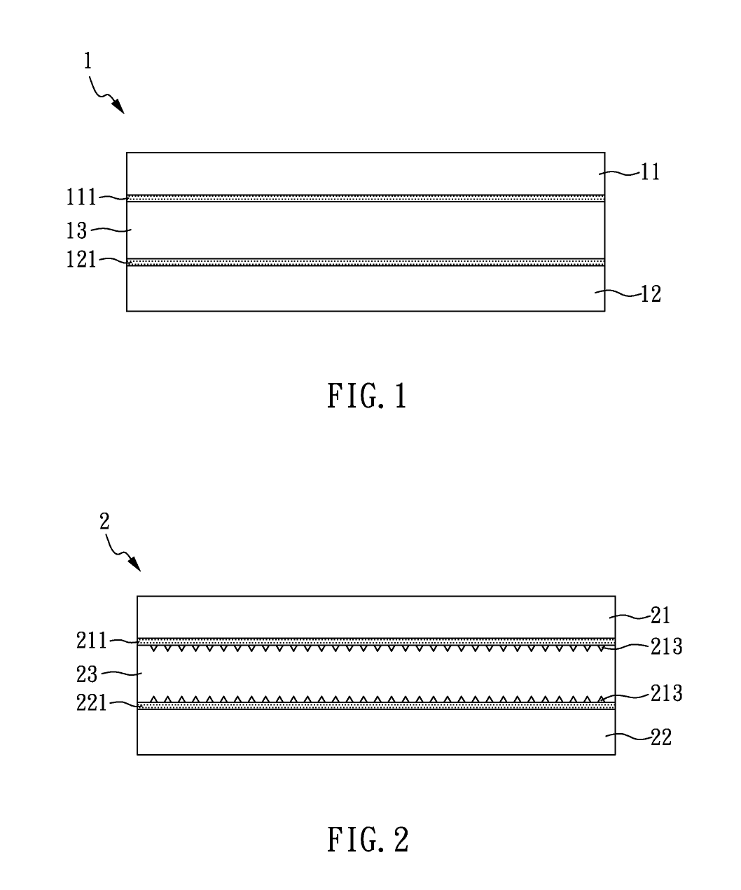

Preparation of liquid crystal display device FIG. 1 shows the schematic structures of the liquid crystal display devices according to Examples 1-3 of the present invention and Comparative Example. The liquid crystal display device 1 includes: a first substrate 11 with a first alignment layer 111 disposed thereon; a second substrate 12 with a second alignment layer 121 disposed thereon; and a liquid crystal layer 13 including a negative liquid crystal composition (not shown) and interposed between the first substrate 11 and the second substrate 12; wherein the first alignment layer 111 and the second alignment layer 112 are disposed substantially parallel and opposite to each other, and the characteristics of the first alignment layer and the second layer are summarized in Table 1 below.

### Examples 1 to 3

Referring to FIG. 1 together with Table 1, the first alignment layer 111 and the second alignment layer 112 used in the liquid crystal display devices of Examples 1-3 were the photo alignment layers made of a polyimide-based polymer and treated by a photo alignment process. The process conditions of the photo alignment, volume resistivity and the absorption wavelength thereof are summarized in Table 1. The volume resistivity of the alignment layers in Examples 1-2 was measured after the alignment layer was coated on a plain glass substrate and irradiated by a linearly polarized light having a wavelength of 254 nm; while the volume resistivity of the alignment layers in Examples 3 was measured after the alignment layer was coated on a plain glass substrate and irradiated by a linearly polarized light having a wavelength of 365 nm, but the present invention is not limited thereto.

### Comparative Example

Referring to FIG. 1 together with Table 1, in Comparative Example, rubbing alignment layers made of a polyimide-based polymer and treated by a rubbing alignment process were used as the first alignment layer 111 and second alignment layer 112. The volume resistivity thereof is summarized in Table 1. As can be seen, they cannot absorb the light having a wavelength of 240 nm to 400 nm.

TABLE 1

| | Alignment | Volume resistivity | Absorption |
|---|---|---|---|
| | process | (Ω · cm) | wavelength (nm) |
| Example 1 | photo | 2.4 × 10¹³ | 240-320 |
| | alignment | | |
| Example 2 | photo | 7 × 10¹² | 240-320 |
| | alignment | | |
| Example 3 | photo | 1.6 × 10¹² | 300-400 |
| | alignment | | |
| Comparative | rubbing | 5.3 × 10¹² | — |
| Example | alignment | | |

Photo alignment process conditions:
UV wavelength: linearly polarized light of 240-365 nm;
UV illuminance: 5-80 mW;
Irradiation time: 1 to 200 seconds;
Photo alignment table speed: 4-500 mm/s;
Total energy: 0.01 J-5 J.
Rubbing alignment process conditions:
Roller speed: 800-1600 rpm;
Table speed: 10-100 mm/s;
Depth: 0.2-0.55 mm.

### Example 4

FIG. 2 shows the schematic structure of the liquid crystal display device according to Example 4. The liquid crystal display device 2 comprises: a first substrate 21 with a first alignment layer 211 disposed thereon; a second substrate 22 with a second alignment layer 221 disposed thereon; and a liquid crystal layer 23 including a negative liquid crystal composition (not shown) and interposed between the first substrate 21 and the second substrate 22; wherein the first alignment layer 211 and the second alignment layer 221 are substantially parallel and opposite to each other, and the surfaces of the first alignment layer 211 and the second alignment layer 221 include a UV reactive monomer (not shown). In this Example 4, the compound of Formula (I) was used as the UV reactive monomer, and based on the total weight of the negative liquid crystal composition, 0.3 wt % of the UV reactive monomers was dispersed in the negative liquid crystal composition. Then, the negative liquid crystal composition was disposed between the first substrate 21 and the second substrate 22, and the UV reactive monomer may deposit on the surfaces of the first alignment layer 211 and the second alignment layer 221 due to phase separation, thus forming a plurality of protrusions 213.

### Test Examples 1 to 4

In Test Examples 1-4, the variance in voltage holding ratio (VHR) of the liquid crystal display device prepared in Examples 1-3 and Comparative Example was tested at ambient temperature from a room temperature to 60° C. As shown in Table 2, compared to the VHR descent rate (Δ=17.2%) of the liquid crystal display device prepared in Comparative Example, since the alignment layers of the liquid crystal display devices prepared in Example 1-3 had a volume resistivity of 1.5×10¹² to 9×10¹⁵ Ω·cm and can absorb a light having a wavelength of 240 nm to 400 nm, electrons or radicals generated in the negative liquid crystal composition due to heat or irradiation by an external ambient light may be effectively reduced, thereby improving the voltage holding ratio of the prepared liquid crystal display device.

TABLE 2

| | VHR | | |
|---|---|---|---|
| | t = 25° C. | t = 60° C. | Δ |
| Example 1 | 96.4 | 87.7 | 8.7 |
| Example 2 | 97.3 | 87.6 | 9.7 |
| Example 3 | 98.6 | 97.6 | 1.0 |
| Comparative | 94.8 | 77.6 | 17.2 |
| Example | | | |

In the above Test Examples 1-4, since the first and second alignment layers of Example 1-3 had the specific volume resistivity ranging from 1.5×10¹² to 9×10¹⁵ Ω·cm or can absorb a light having a wavelength of 240 nm to 400 nm, all the above-described liquid crystal display devices prepared in Examples 1 to 3 had an excellent performance on the voltage holding ratio (Δ<10%). Conversely, as shown in Table 2, since all the first and second alignment layers of Comparative Example did not have a high volume resistivity and cannot absorb the light of the above wavelength range, when the liquid crystal layer is heated or irradiated by an external ambient light to generate electrons or radicals, the voltage holding ratio (VHR) may be decreased due to the loss of the electrons or radicals from the alignment layer, resulting in poor voltage holding ratio (Δ>15%).

In Example 4, since the UV reactive monomer may absorb the external ambient light of above wavelength range or/and react with radicals, electrons or radicals generated in the negative liquid crystal composition due to irradiation by external ambient light may be effectively reduced, thereby improving the voltage holding ratio of the prepared liquid crystal display device prepared in Example 4. Further, it should be understood that in addition to the method as described above in Example 4, the UV reactive monomer may be formed on the surfaces of the first alignment layer and the second alignment layer through formation of a chemical bonding (e.g., a covalent bond) therewith, so as to achieve the absorption of external ambient light. In addition, in Example 4, using the compound of Formula (I) as the UV reactive monomer of the present invention is merely illustrative, and those having ordinary skill in the art can also use any of the compounds of Formula (II) to Formula (IV) or a combination of two or more of the compounds of Formula (I) to Formula (IV) as the UV reactive monomer of the present invention, but the present invention is not particularly limited thereto.

Although the present invention has been explained in relation to its preferred embodiment, it is to be understood that many other possible modifications and variations can be made without departing from the spirit and scope of the invention as hereinafter claimed.

What is claimed is:

1. A liquid crystal display device, comprising:
a first substrate with a first alignment layer disposed thereon;
a second substrate with a second alignment layer disposed thereon; and
a liquid crystal layer, comprising a negative liquid crystal composition and interposed between the first substrate and the second substrate,
wherein the first alignment layer and the second alignment layer are disposed opposite to each other, and at least one of the first alignment layer and the second alignment layer has a volume resistivity of 1.5×10¹² to 9×10¹⁵ Ω·cm.

2. The liquid crystal display device of the claim 1, wherein at least one of the first alignment layer and the second alignment layer has the volume resistivity of 2×10¹³ to 9×10¹⁵ Ω·cm.

3. The liquid crystal display device of the claim 1, wherein at least one of the first alignment layer and the second alignment layer absorbs a light having a wavelength of 240 nm to 400 nm.

4. The liquid crystal display device of the claim 1, wherein the first alignment layer and the second alignment layer are each independently a photo alignment layer.

5. The liquid crystal display device of the claim 1, wherein a surface of at least one of the first alignment layer and the second alignment layer comprises a plurality of protrusions formed by polymerizing UV reactive monomers.

6. The liquid crystal display device of the claim 5, wherein the UV reactive monomer is at least one selected from the group consisting of the following compounds: 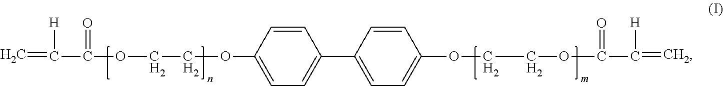
wherein, 0≦m≦5, 0≦n≦5; 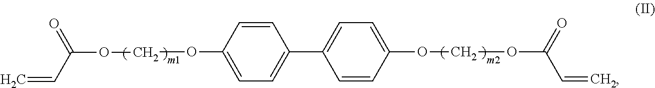
wherein, 1≦m1≦7, 1≦m2≦7; 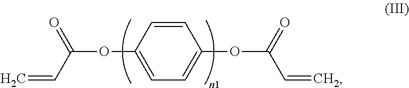
wherein, 1≦n1≦5, and 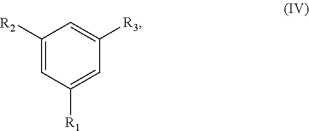
wherein, R₁, R₂ and R₃ are each independently an acrylic group having the formula:

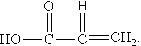

7. The liquid crystal display device of the claim 5, wherein the UV reactive monomer is further included in the liquid crystal layer.

8. A liquid crystal display device, comprising:
a first substrate with a first alignment layer disposed thereon;
a second substrate with a second alignment layer disposed thereon; and
a liquid crystal layer, comprising a negative liquid crystal composition and interposed between the first substrate and the second substrate,
wherein the first alignment layer and the second alignment layer are disposed opposite to each other, and a surface of at least one of the first alignment layer and the second alignment layer comprises a plurality of protrusions formed by polymerizing UV reactive monomers.

9. The liquid crystal display device of the claim 8, wherein the UV reactive monomer is at least one selected from the group consisting of the following compounds: 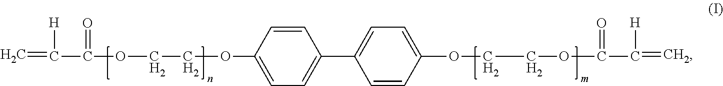
wherein, 0≦m≦5, 0≦n≦5; 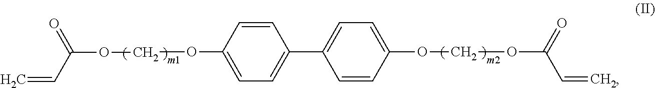
wherein, 1≦m1≦7, 1≦m2≦7; 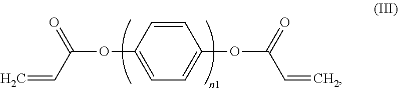
wherein, 1≦n1≦5; and 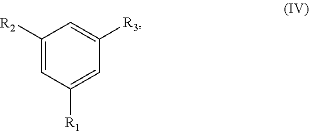
wherein, R₁, R₂ and R₃ are each independently an acrylic group having the formula:

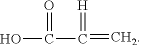

10. The liquid crystal display device of the claim 8, wherein the UV reactive monomer is further included in the liquid crystal layer.

11. The liquid crystal display device of the claim 8, wherein at least one of the first alignment layer and the second alignment layer has a volume resistivity of 1.5×10¹² to 9×10¹⁵ Ω·cm.

12. The liquid crystal display device of the claim 11, wherein at least one of the first alignment layer and the second alignment layer has the volume resistivity of 2×10¹³ to 9×10¹⁵ Ω·cm.

13. The liquid crystal display device of the claim 8, wherein at least one of the first alignment layer and the second alignment layer absorbs a light having a wavelength of 240 nm to 400 nm.

14. The liquid crystal display device of the claim 8, wherein the first alignment layer and the second alignment layer are each independently a photo alignment layer.
